(19) United States
(12) Patent Application Publication
(10) Pub. No.: US 2015/0033276 A1
(43) Pub. Date: Jan. 29, 2015

(54) METHOD AND SYSTEM FOR MANAGING MULTIMEDIA QUALITY OF EXPERIENCE IN A TRANSPORT-INDEPENDENT FASHION

(71) Applicants: Bhumip Khasnabish, Lexington, MA (US); Gerard M.X. Fernando, Mountain View, CA (US)

(72) Inventors: Bhumip Khasnabish, Lexington, MA (US); Gerard M.X. Fernando, Mountain View, CA (US)

(73) Assignee: ZTE (USA) Inc., Richardson, TX (US)

(21) Appl. No.: 14/374,171

(22) PCT Filed: Jan. 28, 2013
(86) PCT No.: PCT/US2013/023364

§ 371 Date: Jul. 23, 2014

Related U.S. Application Data
(60) Provisional application No. 61/592,726, filed on Jan. 31, 2012.

(51) Int. Cl. H04N 21/24; H04N 21/2381; H04N 21/233; H04N 21/439; H04N 21/61; H04L 29/06; H04N 21/433

(52) U.S. Cl. CPC H04N 21/2401; H04L 65/80; H04N 21/2381; H04N 21/433; H04N 21/439; H04N 21/6125; H04N 21/233
USPC 725/116

(57) ABSTRACT

Systems and methods are disclosed which adjust virtualized resources for delivery of a real-time multi-media session to a user terminal. Based on resource parameters, setting resource requirements, the user terminal sets resource requirements for delivery of the real-time multi-media session. The user terminal allocates the resources in accordance with the set resource requirements. The user terminal then continually determines if the distributed resources are sufficient for a desired quality of experience. If the distributed resources are not sufficient, at the user terminal adjusts the allocation of resources by procuring resources from a management of resources (MRD)/resources pre-positioning policy (RPP) database, to maintain the desired quality of experience. The resource parameters may include historic trends of resource allocation of delivery of audio, video, and/or text-messaging, current resource allocation trends, optimization criteria, traffic signature generation, and the like.

### FIELD OF THE INVENTION

The field of the present invention is session-based multimedia services, and more particularly, controlling the quality of experience (QoE) for session-based multimedia services over an Internet-Protocol (IP) based network including the Internet.

### BACKGROUND

Emerging highly-demanding applications and services need proactive quality of experience (QoE) management to reduce customer churn and improve experiences. The traditional reactive quality of service (QoS)-based schemes for improving user experience may not be acceptable due to slow response time and requirements to allocate excessive overhead.

Currently used QoE management techniques used on Internet Engineering Task Force (IETF) protocols and mechanisms that utilize QoS management of transport layer (of ISO's seven-layer OSI model) parameters like latency/delay, jitter/delay-variation, and packet loss.

The mechanisms used to monitor packet delay, jitter, and loss commonly require additional overhead on the transport layer because of the incorporation of monitoring channels and/or messages that may need to be exchanged between the client and server, or among communicating peers.

In addition, bandwidth pre-allocation and over-provisioning may be used for QoE maintenance. This pre-allocation and over-provisioning of resources often leads to under-utilization of resources which may not acceptable in today's goal of cost-effective network operations.

Therefore, it would be advantageous for such an environment to deploy proactive end-point based mechanisms that utilize the dynamic characteristics of network transport. Consequently, the session may achieve a QoE that exceeds the expected regime without utilizing excess transport resources. These mechanisms utilize transport dynamics as inputs and adjust the endpoint presentations to effectively improve the expected QoE.

### SUMMARY OF THE INVENTION

Aspects of the present invention overcome multiple drawbacks as discussed above (a) without incurring any overhead in the transport network, (b) utilizing virtualization at the endpoint, and (c) using a balanced combination of look-ahead/-back and error correction/concealment.

In one aspect, a method adjusts virtualized resources for delivery of a real-time multi-media session to a user terminal. Based on resource parameters, setting resource requirements, the user terminal sets resource requirements for delivery of the real-time multi-media session. The user terminal allocates the resources in accordance with the set resource requirements. The user terminal then continually determines if the distributed resources are sufficient for a desired quality of experience. If the distributed resources are not sufficient, at the user terminal adjusts the allocation of resources by procuring resources from a management of resources (MRD)/resources pre-positioning policy (RPP) database, to maintain the desired quality of experience. The resource parameters may include historic trends of resource allocation of delivery of audio, video, and/or text-messaging, current resource allocation trends, optimization criteria, traffic signature generation, and the like.

### BRIEF DESCRIPTION OF THE DRAWINGS

FIG. 1 shows a high-level block diagram of open-loop QoE management.

FIG. 2 presents a list of features/functions that are required in the toolkit for open-loop QoE management.

FIG. 3 illustrates multi-layer elastic virtualized buffer blocks for open-loop QoE management

FIG. 4 is a schematic illustrating transport rate clinging.

FIG. 5a shows a schematic for dynamically adjusting virtualized resources among sub-sessions (audio, video, text/messaging, etc.).

FIG. 5b presents a flowchart for dynamically adjusting virtualized resources among sub-sessions (audio, video, text/messaging, etc.).

FIG. 6 is a schematic illustrating dynamic recognition of a traffic signature and the use of optimization of resources.

### DETAILED DESCRIPTION OF EMBODIMENTS

Aspects of the present invention overcome drawbacks concerning the execution of real-time delivery of multi-media sessions (a) without incurring overhead in the transport network, (b) utilizing virtualization at the endpoint, and (c) using a balanced combination of look-ahead/-back and error correction/concealment.

Once a session starts with a specific transport bandwidth, one of the endpoint's objective is to maintain a consistent quality of experience even when the session bandwidth fluctuates. The intelligence resides at the endpoint, or user terminal, and the use of virtualization makes the implementation a technically feasible one.

One of the mechanisms utilized in aspects of the present invention is based on the commonly used high-performance and self-adapting high-end video encoders and decoders in networked (distributed) environment. For example, one of the mechanisms is based on the principle of multi-layer coding and automatic correction of errors including error concealment. Another mechanism is the adaptation of the rate at which information/packet is fed to the buffer of the rendering device. This is based on the video trick mode similar to the value-added features/functions of VCR or video cassette recorder which allows for slow or fast movement (forward and reverse) of session information based on the receipt of information/packet from the storage, but in this case the transport network.

Another feature is pre-positioning, including dynamic adjustment of resources among the entities, of the elements of multimedia session with an objective to maintain or exceed the desired target quality of experience (QoE) parameters. For example, resources used for maintaining video frame rate and pixel resolution of a session may be traded with those used for audio and messaging parts of the same session.

Another feature is the capability to emulate the perceptual parameters utilizing resources (real or virtualized) on an on-demand basis at the endpoint. This may include proactive correction related to bandwidth and quality of transport degradation, e.g., concealment of perceived impairments that are caused by the instantaneous reduction of bandwidth and the erroneous/fragmented transmission of information. For example, (a) adjustment of audio type (mono, stereo, surround, etc.) and volume may be tolerated more than freezing or fragmentation of a picture frame, (b) a little more delay in delivering the text/message in the ‘Instant Message’ window may be more tolerated more than absolute silence in the audio, and so on.

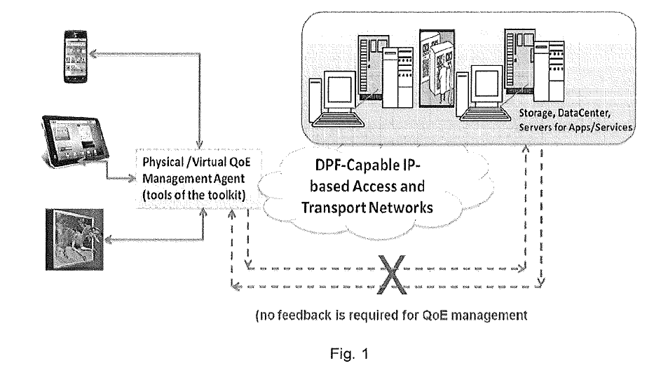

FIG. 1 illustrates a high-level block diagram of an open-loop QoE management mechanism. Although a QoE management agent could be physical or virtual, it resides in both the device (user terminal) and access network.

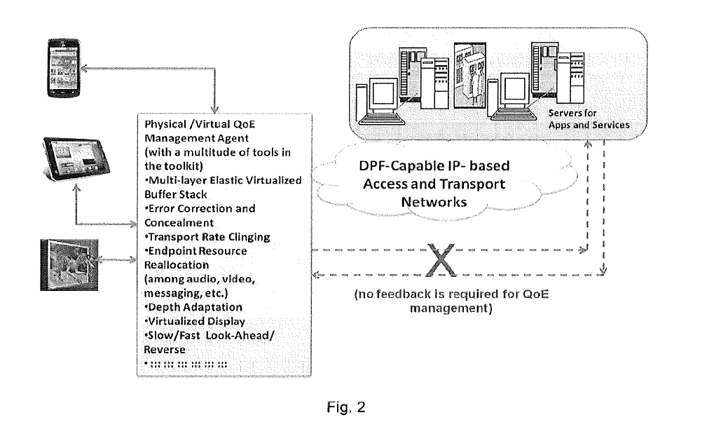

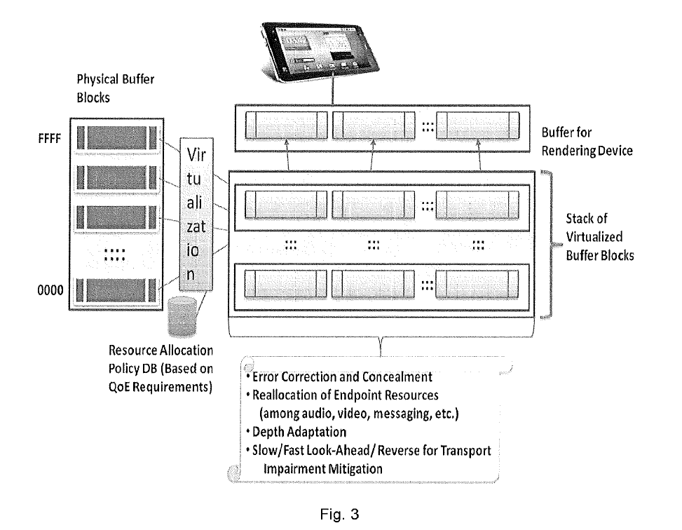

Features/functions which are components of a toolkit for open-loop QoE management, according to aspects of the present invention, are shown in FIG. 2. This list includes the following:
Multi-layer Elastic Virtualized Buffer Stack
Error Correction and Concealment
Transport Rate Clinging
Endpoint Resource Reallocation (among audio, video, messaging, etc.)
Depth Adaptation
Virtualized Display
Slow/Fast Look-Ahead/ Reverse. A multi-layer elastic virtualized buffer blocks for open-loop QoE management is illustrated in FIG. 3. Virtualization of a buffer allows an increase of the effectively available buffer over the amount that is actually physically available. This can be achieved, for example, by assigning larger than actual physical buffer/memory chunk so that during execution/operation of a process, a larger memory block can actually be temporarily used. These buffer blocks provide the following functions under the guidance of resources allocation policy based on persistently managing a consistent QoE:
   Error Correction and Concealment
   Reallocation of Endpoint Resources (among audio, video, messaging, etc.)
   Depth Adaptation
   Slow/Fast Look-Ahead/Reverse for Transport Impairment Mitigation

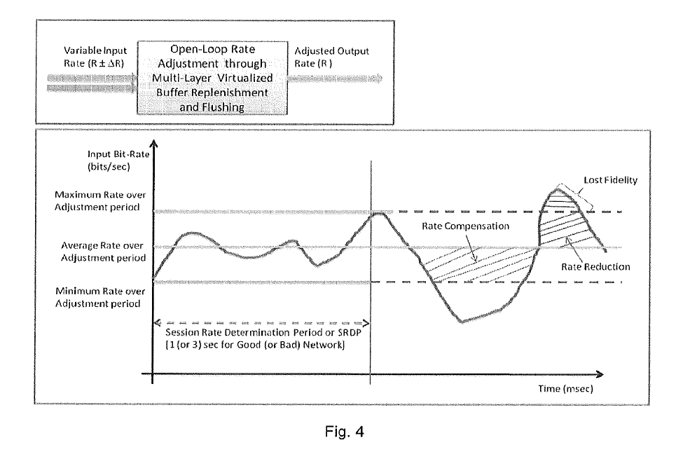

FIG. 4 shows clinging (or attachment to) transport rate during the periods of significant network transport congestion/impairments by using an open-loop rate adjustment method. This method uses multi-layer virtualized buffer replenishment and flushing mechanisms with the sole objective to maintain a consistent QoE.

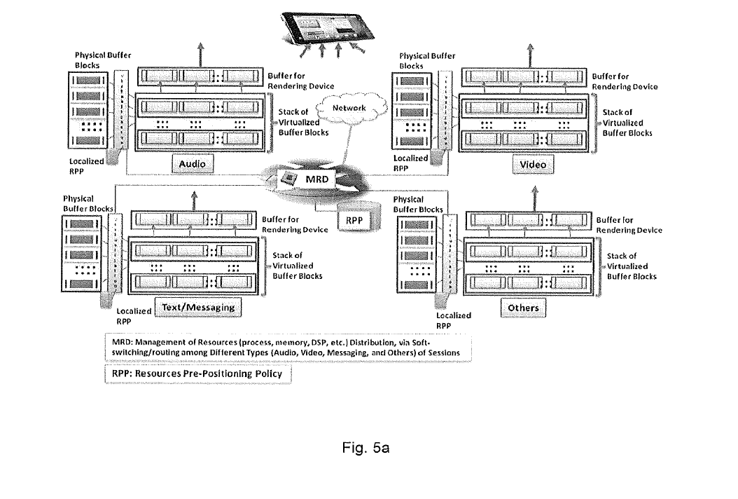

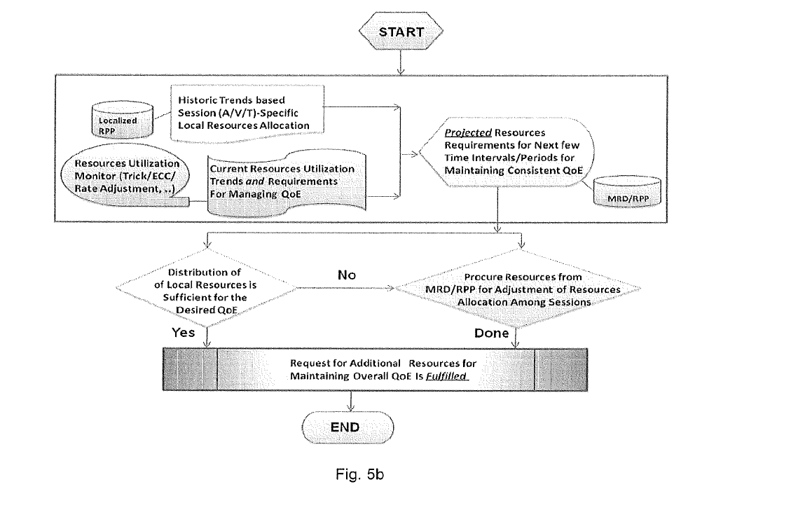

A schematic for dynamically adjusting virtualized resources among sub-sessions (audio, video, text/messaging, etc.) is shown in FIG. 5a. The resources pre-positioning policy (RPP) and MRD or Management of Resources (process, memory, DSP, etc.) Distribution, work in unison via Soft-switching/routing among different types (Audio, Video, Messaging, and others) of sessions to maintain a consistent QoE. A flowchart for dynamically adjusting virtualized resources among sub-sessions (audio, video, text/messaging, etc.) is presented in FIG. 5b. In this algorithm, both historic and expected (or projected) resources utilization/requirement profiles are utilized to maintain a consistent QoE for the ongoing audio, video, and text message exchange sessions.

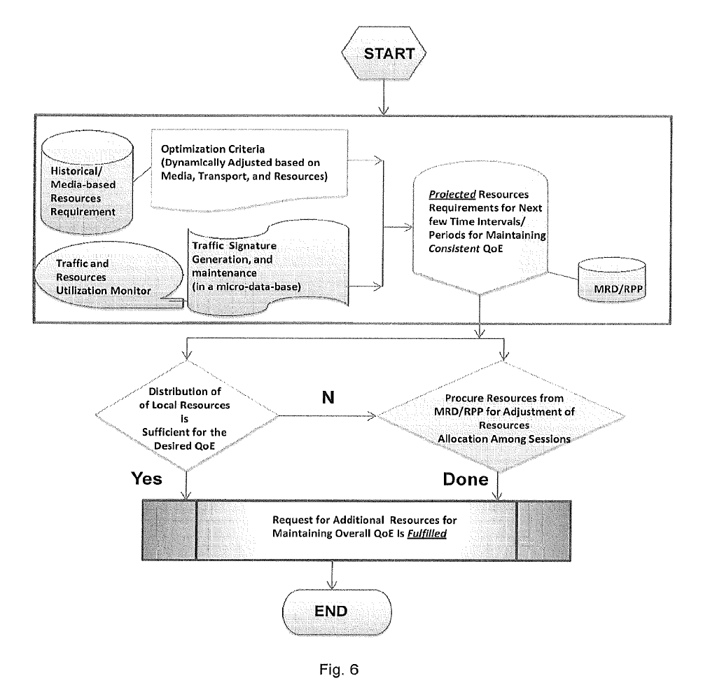

Utilization of the dynamically recognized traffic signatures and other criteria for optimizing resources are used for assigning media streams to flow for delivering the acceptable quality of experience, which is illustrated in FIG. 6.

It should be understood that the methods and systems of the present invention are executed employing machines and apparatus including simple and complex computers. Moreover, the architecture and methods described above can be stored, in part or in full, on forms of machine-readable media. For example, the operations of the present invention could be stored on machine-readable media, such as magnetic disks or optical disks, which are accessible via a disk drive (or computer-readable medium drive). Alternatively, the logic to perform the operations as discussed above, could be implemented in additional computer and/or machine readable media, such as discrete hardware components as large-scale integrated circuits (LSI's), application-specific integrated circuits (ASIC's), firmware such as electrically erasable programmable read-only only memory (EEPROM's); and the like. Implementations of certain embodiments may further take the form of machine-implemented, including web-implemented, computer software.

While aspects of this invention have been shown and described, it will be apparent to those skilled in the art that many more modifications are possible without departing from the inventive concepts that are described herein. The invention, therefore, is not to be restricted except in the spirit of the following claims.

What is claimed is:

1. A method for adjusting virtualized resources for delivery of a real-time multi-media session to a user terminal, the method comprising:
based on resource parameters, setting resource requirements, at the user terminal for delivery of the real-time multi-media session;
allocating, at the user terminal, resources in accordance with the set resource requirements;
determining, at the user terminal, if the distributed resources are sufficient for a desired quality of experience; and
if the distributed resources are not sufficient, adjusting, at the user terminal, the allocation of resources by procuring resources from a management of resources (MRD)/resources pre-positioning policy (RPP) database, to maintain the desired quality of experience.

2. The method of claim 1, wherein the resource parameters comprise traffic signatures and optimization criteria associated with the quality of experience.

3. The method of claim 1, wherein the adjusting comprises the utilization of virtualized buffer blocks.

4. The method of claim 3, wherein the adjusting further comprises adapting a rate at which information is fed to the buffer of the user terminal.

5. The method of claim 3, wherein the adjusting further comprises adjusting an audio type of the multi-media session.

6. The method of claim 3, wherein the adjusting comprises delaying of a delivery a text message to the user terminal.

7. A system for adjusting virtualized resources for delivery of a real-time multi-media session to a user terminal, the system comprising:
a user terminal configured to:
set resource requirements, based on resource parameters, for delivery of the real-time multi-media session;
allocate resources in accordance with the set resource requirements;
determine if the distributed resources are sufficient for a desired quality of experience; and
if the distributed resources are not sufficient, adjust the allocation of resources by procuring resources from a management of resources (MRD)/resources pre-positioning policy (RPP) database, to maintain the desired quality of experience.

8. The method of claim 7, wherein the resource parameters comprise traffic signatures and optimization criteria associated with the quality of experience.

9. The system of claim 7, wherein the user terminal is further configured to utilize virtualized buffer blocks.

10. The system of claim 9, wherein the user terminal is further configured to adapt a rate at which information is fed to the buffer of the user terminal.

11. The system of claim 9, wherein the user terminal is further configured to adjust an audio type of the multi-media session.

12. The system of claim 9, wherein the user terminal is further configured to delay a delivery of a text message to the user terminal.

13. An apparatus for adjusting virtualized resources for delivery of a real-time multi-media session to a user terminal, the apparatus comprising:
based on resource parameters, means for setting resource requirements, at the user terminal for delivery of the real-time multi-media session;
means for allocating, at the user terminal, resources in accordance with the set resource requirements;
means for determining, at the user terminal, if the distributed resources are sufficient for a desired quality of experience; and
if the distributed resources are not sufficient, means for adjusting, at the user terminal, the allocation of resources by procuring resources from a management of resources (MRD)/resources pre-positioning policy (RPP) database, to maintain the desired quality of experience.

14. The apparatus of claim 13, wherein the resource parameters comprise traffic signatures and optimization criteria associated with the quality of experience.

15. The apparatus of claim 13, wherein the means for adjusting comprises means for utilizing of virtualized buffer blocks.

16. The apparatus of claim 15, wherein the means for adjusting comprises means for adapting a rate at which information is fed to the buffer of the user terminal.

17. The apparatus of claim 15, wherein the means for adjusting comprises means for adjusting an audio type of the multi-media session.

18. The apparatus of claim 15, wherein the means for adjusting comprises means for delaying of a delivery a text message to the user terminal.
